(19) United States
(12) Patent Application Publication
(10) Pub. No.: US 2010/0301721 A1
(43) Pub. Date: Dec. 2, 2010

(54) STORAGE BOX WITH SLIDE OUT STORAGE TRAY

(76) Inventor: Michael W. Nebel, Smith Center, KS (US)

Correspondence Address: HOLLAND & HART, 222 South Main Street, Suite 2200, P.O. Box 11583, Salt Lake City, UT, 84110, US

(21) Appl. No.: 12/475,062

(22) Filed: May 29, 2009

(51) Int. Cl. A47B 95/00; B60R 9/06; A47B 96/00; A47B 97/00

(52) U.S. Cl. 312/326; 296/37.6; 211/126.15; 312/333

(57) ABSTRACT

A storage box comprises a housing with open ends and a tray that slides out either open end. Latch members mounted on opposite outer corners of the tray and cooperating with latch keepers on the housing, hold the tray in a centered position and can be released to allow the tray to slide out a selected end of the housing. Stops mounted on the tray engage the latch keepers to limit the length of the tray that may be withdrawn from the housing and to prevent the drawer from sliding completely out either open end. Latch hold downs are formed on doors hingedly connected across the open ends. The latch hold downs engage the latch members when the tray is centered and the doors closed to prevent the door from coming unlatched.

### BACKGROUND OF THE INVENTION

The present invention relates to storage boxes for trucks and in particular storage boxes having a tray for storing tools and other articles and that slide into and out of the storage box.

Numerous types of storage boxes have been developed for storing tools and other equipment on or under the bed of a truck, including pick-up trucks and flat bed trucks. Storage boxes mounted on the bed of the truck typically have a hinged lid to provide access to the tools and equipment stored inside the box. It is also known to provide trays that slide out of an end of the box on rails or glides, in the nature of a drawer. The front face of the tray or drawer will generally function as a closure member or door, closing off the end of the box when the tray is slid into the box.

Problems with existing storage boxes for trucks are numerous. Boxes mounted across the front of the bed with hinged lids generally require climbing onto the truck bed to access the entire interior of the box. Moreover, if the truck is used for hauling material, such as large round bales of hay, it may be impossible to open the box when a bale is stored on the bed and partially over the box. In addition, the area above most existing storage boxes must remain free of objects or obstructions so as not to block opening of the storage box.

Existing slide out trays for truck mounted storage boxes, only slide out to one side or end of the box. It is known to mount two slide out trays in one box, with each drawer extending approximately half the length of the box and sliding out opposite ends. However, such trays limit the length of an item that can be stored therein to less than half the width of the truck bed.

In slide out tool trays wherein the end of the tray forms the door for closing the box, if the seals around the door fail, water that leaks into the box is likely to travel down the inside surface of the door and into the tool tray. Water, which then collects in the bottom of the tray, dampens the tools and equipment stored therein, promoting rust and damage to the stored articles.

Slide out trays also must be capable of being securely locked in place when in the stored position as the truck is moving. In storage compartments for slide out trays which are closed off by a separate hinged door, if the tray comes unlatched and slides even an inch or so as the truck rounds a corner, the force of the tray sliding against the door can damage the door, or worse force the door open and allowing the tray to slide out while the truck is moving.

There remains a need for an improved storage box with a slide out tray for use with secondary structures such as vehicles, including pick-up and flat bed trucks that addresses the foregoing problems.

### SUMMARY OF THE INVENTION

The present invention is directed to a storage box for mounting to a secondary structure, such as the bed or frame of a truck, trailer or other vehicle, and which includes a storage tray that slides out either open end of the storage box housing. The storage box housing includes a pair of spaced apart sidewalls, a cover panel and first and second open ends. The tray is slidably mounted within the housing on bearings which are connected to and project inward from the sidewalls. Doors, connected to the housing across first and second open ends respectively, are selectively advanceable into and out of closed relationship with the open ends of the housing to enclose the storage tray retracted into the housing and protect items stored in the tray from precipitation.

The storage box utilizes a pair of latch assemblies generally located proximate opposite corners of the storage box to hold the storage tray in a retracted position. A first latch assembly includes a first movable latch member and a first latch keeper. The first latch member is pivotally mounted on a front sidewall of the tray proximate a first end thereof. The first latch keeper is connected to and projects inward from the front sidewall of the storage box housing. A second latch assembly similarly includes a second movable latch member and a second latch keeper. The second latch member is pivotally mounted on a rear sidewall of the tray proximate a second end thereof and the second latch keeper is connected to and projects inward from the rear sidewall of the storage box housing. When the tray is centered within the housing, which may be referred to as the retracted position, fingers on the first and second latch members engage inner surfaces of the first and second latch keepers respectively to prevent the tray from sliding past the latch members in either direction out of the housing open ends. Pivoting of a selected latch member upward advances the associated finger out of engagement with the corresponding latch keeper so that the tray may be slid past the latch member and out of the corresponding open end.

A first stop is connected to and projects outward from the front sidewall of the tray and a second stop is connected to and projects outward from the rear sidewall of the tray. The stops are mounted on the tray sidewalls behind or inward relative to the latch keeper a selected distance, corresponding to the distance that the tray can be withdrawn from the housing. When the tray is pulled or slid out of the housing through the first opening the selected distance, the stop projecting outward from the front sidewall of the tray engages or abuts against the latch keeper projecting inward from the housing front sidewall to prevent further outward sliding of the tray through the first opening. When the tray is pulled or slid out of the housing through the second opening the selected distance, the stop projecting outward from the rear sidewall of the tray engages or abuts against the latch keeper projecting inward from the housing rear sidewall to prevent further outward sliding of the tray through the second opening. Inwardly facing edges of the latch member fingers are downwardly and outwardly sloped so that when the tray is slid back to the retracted position, the inward facing edges of the fingers function as a cam surface to pivot the latch member over the latch keeper. When the tray is fully retracted and the finger has traveled inward past the latch keeper, the latch member pivots back downward by gravity so that the finger extends behind the associated latch keeper, which prevents the tray from sliding outward from the retracted position.

A latch engagement member is mounted on each door of the housing. When the door is closed, the latch engagement member engages the associated pivotal latch member and holds it in position to prevent the latch member from inadvertently becoming disengaged from the latch keeper which would allow the tray to slide within the housing.

### BRIEF DESCRIPTION OF THE DRAWINGS

FIG. 1 is a perspective view of a storage box mounted on a flat bed truck with a storage tray extending partially out a left end of the storage box and with portions of a cover for the storage box removed to show interior details.

FIG. 2 is an enlarged and fragmentary, perspective view of the storage box as shown in FIG. 1 with portions of the storage box removed to show interior detail of the storage tray and the side rails on which the tray is mounted and with the storage tray shown fully extended to the left relative to side rails.

FIG. 3 is a greatly enlarged and fragmentary perspective view of the storage tray slide to the left relative to side rails as in FIG. 3.

FIG. 4 is an enlarged and fragmentary perspective view of the storage tray as shown in FIG. 1.

FIG. 5 is a fragmentary rear view of the storage box as shown in FIG. 1 with a rear cover panel removed to show interior detail.

FIG. 6 is an enlarged and fragmentary view of a portion of the storage box as shown in FIG. 5.

FIG. 7 is a perspective view of an alternative embodiment of the storage box integrated into a headache rack of a flatbed truck.

### DETAILED DESCRIPTION OF THE INVENTION

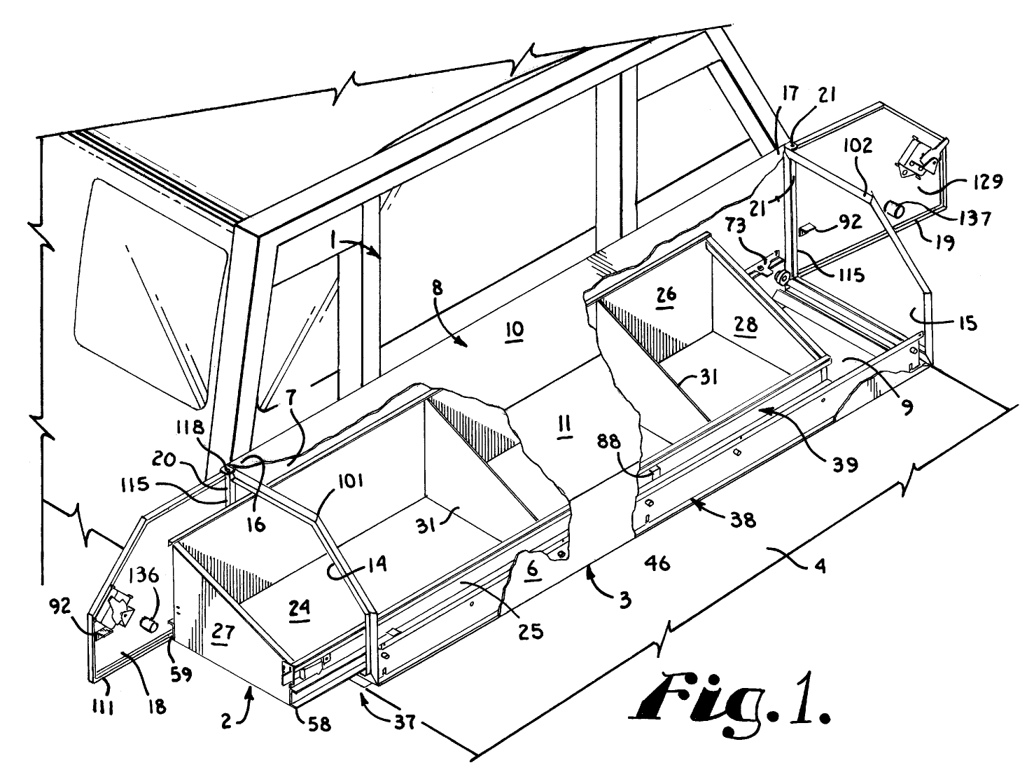

Referring to the drawings in more detail, the reference numeral 1 refers to a storage box having storage tray 2 slidably mounted within a storage box housing 3 so that the tray 2 slides out either end of the housing 3. The storage box 1 is particularly well adapted for mounting on vehicles 4 such as trucks or trailers and is shown mounted on a flat bed truck in FIG. 1. The storage box 1 may be sold as an accessory to be attached to the vehicle after the initial production of the vehicle. As described herein, directional references with respect to the storage box 1, storage tray 2 and the housing 3 generally correspond to the orientation of the box 1 as accessed by a user, which is generally opposite of the typical directional references applied to the vehicle 4. More specifically, the box 1 as shown in the embodiment of FIG. 1 faces in an opposite direction of the vehicle so that the front of the storage box 1 faces the rear of the truck 4 and the rear of the box 1 faces the front of the truck 4. As the user faces the front of the box 1, the left side of the box 1 is to the user's left and the right side of the box is to the user's right.

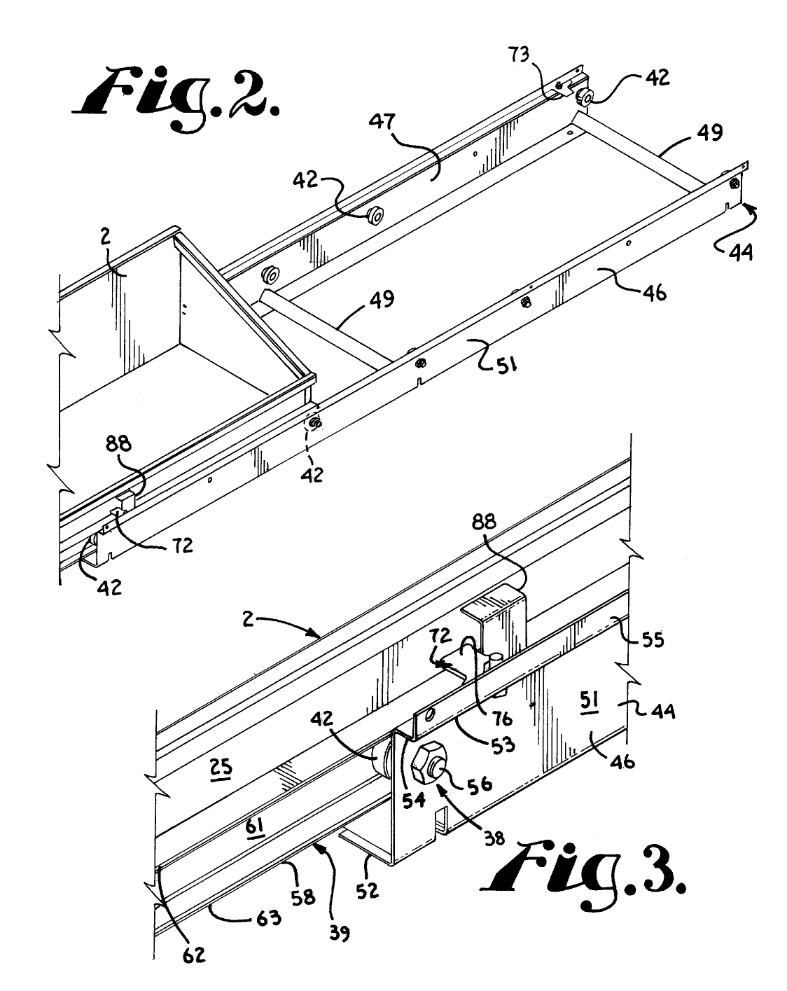

The storage box housing 3 of the embodiment shown, includes a front panel or sidewall 6, a rear panel or sidewall 7 a cover 8 and an open bottom 9. The cover 8 of the embodiment shown in FIGS. 1 and 2 includes a horizontal top panel 10 and an angled front face or panel 11 sloping downward from the top panel 10 to the front sidewall 6 at an angle of approximately forty five degrees. Left and right openings 14 and 15 are formed in left and right ends 16 and 17 of the housing. Left and right side doors 18 and 19 are connected by hinges 20 and 21 to the rear sidewall 7 of the housing 3 adjacent the left and right openings 14 and 15 respectively. The doors 18 and 19 are pivotable into and out of covering relationship with the openings 14 and 15 respectively.

Front and rear flanges (not shown) are formed on and project inward from the front and rear housing sidewalls 6 and 7 respectively. The upper surface of the bed of the flat bed truck generally forms the bottom of the storage box 1, so the bottom 9 of the housing is left open between the flanges.

The storage tray 2 includes a floor or bottom panel 24, front and rear sidewalls 25 and 26, left and right end walls 27 and 28 and an open top. In the embodiment shown, the rear sidewall 26 is taller than the front sidewall 25 and the end walls 27 and 28 slope downward from back to front. Various dividers 31, tool holders, smaller storage trays and the like can be mounted in or to the primary storage try 2 to organize and hold tools and other equipment or supplies within the storage box 1.

The storage tray 2 is slidably or rollably mounted within the storage box 1 on a glide assembly 37 which is similar in function to a drawer slide which is best seen in FIGS. 2 and 3. The glide assembly 37 includes a first glide sub-assembly 38 connected to the housing 3 and a second glide sub-assembly 39 connected to the tray 2. The first glide sub-assembly 38 includes a plurality of rollers or roller bearings 42 rotatably mounted on a roller bearing frame 44 which is bolted or otherwise connected to the housing sidewalls 6 and 7 such that the roller bearings 42 may be described as being connected to and part of the front and rear sidewalls 6 and 7 of the housing 3.

The roller bearing frame 44 includes front and rear roller support beams 46 and 47 interconnected by a plurality of cross members 49. Each roller support beam 46 includes a vertical web 51 with a lower flange 52 formed along and projecting inward from a lower edge of the web 51 and an upper flange 53 formed along and projecting outward from an upper edge of the web 51. The upper flange 53 includes a horizontal leg 54 and a vertical leg 55 that extends upward from a distal end of the horizontal leg 54. The vertical leg 55 includes a plurality of bolt or screw holes formed therein (one shown in FIG. 3) for connecting the roller support beam 46 or 47 to an inner surface of the corresponding housing sidewall 6 or 7 respectively. The lower flange 52 of each roller support beam 46 and 47 are supported on the flanges projecting inward from the housing sidewalls 6 and 7. Screw holes (not shown) are formed in the lower flanges 52 near left and right ends 16 and 17 of the housing to facilitate driving of a screw therethrough to secure the storage box 1 to a surface such as the bed of a flat bed truck 1. It is to be understood that because the roller support beams 46 and 47 are connected to the housing, they may be considered part of the housing 3.

The roller bearings 42 are mounted on shafts 56 which extend through the vertical web 51 and are bolted or otherwise secured to the vertical web 51. The roller bearings 42 are secured in spaced relation on the support beams 46 and 47 and project inward therefrom. The axes of the rollers 42 extend in horizontal alignment.

The second glide sub-assembly 39, mounted on the tray 2 comprises front and rear channel members 58 and 59 connected to the front and rear sidewalls 25 and 26 respectively. Each channel member 58 and 59 includes a vertical web 61 which abuts and is secured to the associated sidewall 25 and 26 and upper and lower, outwardly projecting legs 62 and 63. The channel members 58 and 59 preferably run the full length of the tray sidewalls 25 and 26 in horizontal alignment.

The tray 2 is glidingly mounted on the rollers 42 such that the rollers 42 extend between the upper and lower legs 62 and 63 of the channel members 58 and 59 on the tray sidewalls 25 and 26. The upper leg 62 of each channel member 58 and 59 bears down on and is supported by the rollers 42 such that the tray 2 rolls on rollers 42 and glides or slides into and out of the housing 3.

The tray 2 is shorter than the housing 3. When the tray 2 is centered relative to the housing 3 as shown in FIG. 5, which may be referred to as a retracted or centered position, the tray 2 is completely enclosed by the housing 3. From the retracted position, the tray may slide in either direction, out either the left or right opening 14 or 15 in housing 3. As will be discussed in more detail below, the tray 2 can slide out either opening preferably at least fifty percent of its length and in the embodiment shown approximately sixty-five percent or in some embodiments up to approximately eighty percent of its length to a left extended position (as shown in FIG. 2) or a right extended position to allow access to the contents of the tray 2.

As best seen in FIG. 5, which is a rear view of the storage box with the rear panel removed to show detail, left and right side latch assemblies 67 and 68 are located proximate opposite corners of the storage box and operate to hold the storage tray 2 in the centered or retracted position. The latch assemblies may be selectively released to allow the tray 2 to slide out either open end of the housing 3. Each latch assembly 67 and 68 is of the same construction and includes a movable latch member and a latch keeper.

In the embodiment shown, a first moveable latch member 70 is pivotally mounted on the front sidewall 25 of the tray proximate the left end wall 27 and a second moveable latch member 71 is pivotally mounted on the rear sidewall 26 of the tray 2 proximate the right end wall 28. A first latch keeper 72 is bolted to the front roller support beam 46 proximate a left end thereof and projects inward relative to the support beam 46 and a second latch keeper 73 is bolted to the rear roller support beam 47 proximate a right end thereof projecting inward relative to the support beam 47.

Each latch keeper 72 and 73 is generally formed from a planar piece of sheet metal bolted to the associated roller support beam 46 or 47 respectively. Each keeper 72 and 73 includes an inwardly projecting leg 76 projecting generally perpendicular to and inward relative to the associated roller support beam 46 or 47. The inwardly projecting latch keeper leg 76 is generally rectangular.

Each moveable latch member 70 and 71 comprises a lever, having a pivot end 77, a grip end 78 and a central portion 79 with a latch finger or tooth 80 projecting downward from the central portion 79. Each latch member 70 and 71 is pivotally connected to the associated tray sidewall 25 and 26 respectively at the pivot end 77. The grip end 78 of each latch member 70 and 71 extends through a slot 83 formed in a guide plate 84 mounted on the tray end walls 27 and 28. The slot 83 limits the range of motion or pivoting of the latch members 70 and 71 between lowered and raised positions. In the lowered position, the latch members 70 and 71 extend generally horizontally. The grip end 78 of each latch member 70 and 71 extends approximately an inch past the associated end wall 27 and 28 of the tray 2.

An inner edge 86 of each latch finger 80 slopes downward and outwards, towards the corresponding open end 16 and 17 of the housing 3. An outer edge 87 of each latch finger 76 extends vertically when the latch members 70 and 71 are in the lowered position. The moveable latch members 70 and 71 and the latch keepers 72 and 73 are positioned so that when the tray 2 is in the centered or retracted position, the outer edge 87 of each latch finger 76 is positioned just inside of the inwardly projecting leg 76 of the associated latch keeper 72 and 73, thereby preventing the tray 2 from sliding in either direction past the latch keepers 72 and 73.

To slide the tray 2 out either end 16 or 17 of the housing 3, the associated latch member 70 or 71 is raised or pivoted upward to lift the latch finger 80 past the inwardly projecting leg 76 of the latch keeper 72 or 73 respectively. More specifically, to slide the tray 2 out of the left opening 14 in the housing, after opening door 18, the user grasps the grip end 78 of the latch member 70 on the left end of the tray 2 and pivots the latch member 70 upward so that the latch finger 80 is raised above the inwardly directed leg 76 of the latch keeper 72. To slide the tray 2 out of the right opening 15, after opening the door 19, the user pivots the latch member 71 on the right end of the tray 2 upward to disengage the latch finger 80 from the associated latch keeper 73. Once the latch finger 80 is disengaged from or moved from obstructing sliding movement of the tray 2, the user can then pull the tray 2 out the corresponding opening 14 or 15.

First and second stops or stop members 88 and 89 are mounted on the front and rear sidewalls 25 and 26 respectively of the tray 2 and are positioned to engage the inwardly projecting legs 76 of latch keepers 72 and 73 when the tray 2 is pulled a selected distance out openings 14 or 15 respectively, as shown in FIGS. 2 and 3 with the tray 2 pulled to a left extended position. As discussed above, the preferred distance that the tray 2 may be pulled out of the housing 3 is at least fifty percent of the length of the tray 2 and more preferably approximately sixty to eighty percent of the length of the tray 2. Although full extension would theoretically be preferred, it is not practical to achieve such a high degree of extension with slide out assemblies of the type used.

Therefore, each stop 88 and 89 is mounted on the corresponding tray sidewall 25 and 26 a distance of approximately two thirds the length of the tray 2 from the left and right end respectively. When the tray 2 is slid out the left opening 14 the selected distance, the stop 88 on the tray front sidewall 25 engages the inwardly directed leg 76 of latch keeper 72 connected to the front panel 6 of the housing 3 via the front roller support beam 46 to prevent further extension of the tray 2 out the left opening 14. Similarly, when the tray 2 is slid out the right opening 15 the selected distance, the stop 89 on the tray rear sidewall 26 engages the inwardly directed leg 76 of the second latch keeper 73 connected to the rear panel 7 of the housing 3 via the rear roller support beam 47 to prevent further extension of the tray 2 out the right opening 15. The position of the tray 2 extended out either opening 14 or 15 the selected distance limited by the stops 88 and 89 may be referred to as the left and right extended positions respectively.

Referring to FIG. 2 it can be seen that the stop 88 is positioned so that when the tray 2 is in the left extended position, two rollers 42 are still captured between the upper and lower legs 62 and 63 of the channel members 58 and 59. The left most roller 42 on each side supports or bears the weight of the tray 2 and the next inwardly spaced roller 42 functions as a cantilever support, preventing the front end of the tray 2 from tipping downward about the fulcrum created by the left most rollers 42.

When the tray 2 is advanced back to the retracted position, from the left extended position, the first latch member 70 automatically engages the first latch keeper 72 to hold the tray 2 in the retracted or centered position. More specifically, just prior to the tray 2 reaching the fully retracted position, the downwardly and outwardly sloping inner edge 86 of the latch finger 80 engages the inwardly directed leg 76 of the latch keeper 72, causing the latch member 70 to pivot upward until the latch finger 80 passes over the leg 76 of the latch keeper 72 as the tray 2 is rolled further inward. Once the latch finger 80 passes past the inner edge of the latch keeper leg 76, the latch member 70 is then allowed to pivot downward by gravity so that the outer edge 87 of the latch finger 80 is again positioned just inside of the latch keeper leg 76 to prevent the tray 2 from sliding back out the left opening 14. Simultaneously, engagement of the outer edge 87 of the latch finger 80 of second latch member 71 with the latch keeper 72 on the opposite end of the storage box 1, prevents the tray 2 from sliding out the right side opening 15.

The second latch member 71 interacts with the second latch keeper 73 in a similar manner to allow sliding of the tray 2 between the retracted position and the right extended position and automatic latching of the second latch member 71 to the second latch keeper 73. It is foreseen that a spring could be connected to each latch member 70 and 71 to normally bias or draw the latch members 70 and 71 to a lowered or latched position.

Latch engagement members or hold downs 92 and 93 are mounted on an inner surface of each door 18 and 19 respectively of the housing 3. The latch engagement members 92 and 93 in the embodiment shown are formed from an angle iron or angle member and include a vertical leg 94 and a horizontal leg and 95. The vertical leg 94 is positioned flush with the inner surface of the associated door 18 and 19 and the horizontal leg 95 projects perpendicular thereto. The latch engagement members 92 and 93 are positioned on the doors 18 and 19 so that when the door is closed, the horizontal leg 95 extends just above an upper edge of the latch member grip end 78 when the latch members 70 and 71 are in the lowered or latched position. Extension of the horizontal legs 95 just above the latch members 70 and 71 prevents the latch members 70 and 71 from inadvertently bouncing upward and out of engagement or blocking alignment with the latch keepers 72 and 73 respectively.

In addition, if the tray 2 is not advanced completely to the centered position, the tip of the grip end 78 of latch member 70 or 71 will extend past the associated end 16 or 17 of the housing 3, preventing the door from shutting completely, or the latch finger 80 will be resting on top of the latch keeper 72 or 73, preventing the latch member 70 or 71 from returning to the lowered position. If the latch member 71 is not in the lowered position, the horizontal leg 95 of the latch engagement member will hit the grip end 78 of the latch member 71 when the user tries to shut the door 18 or 19 noticeably preventing the door from shutting and informing the user that the tray 2 is not fully retracted to the centered position.

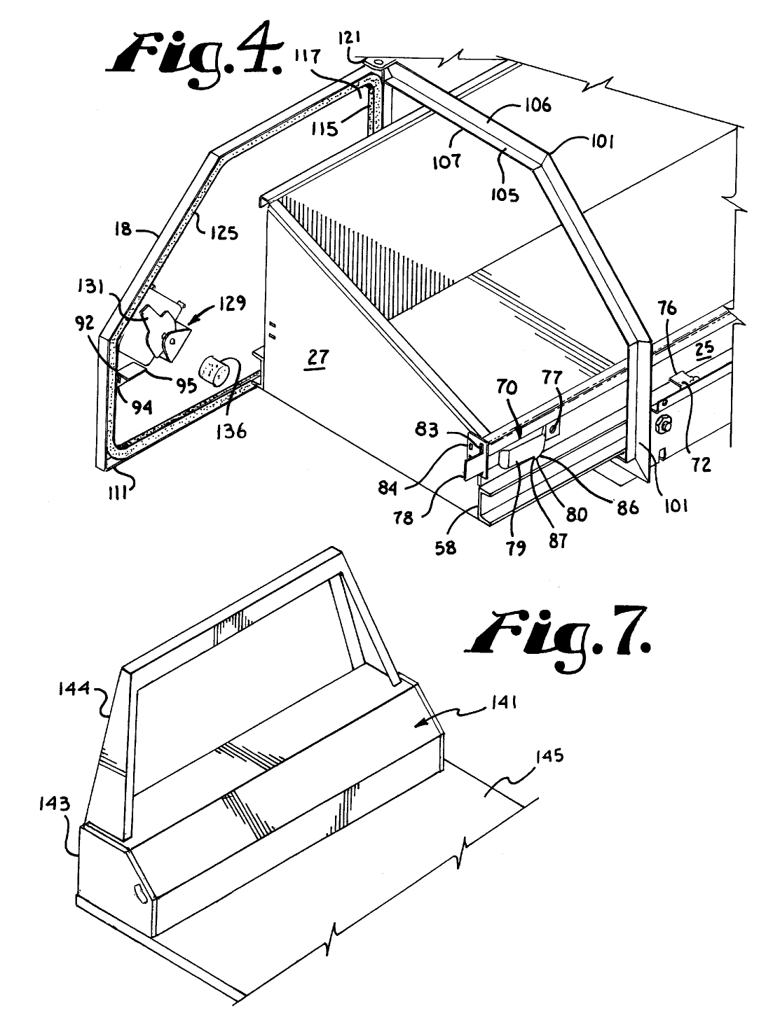

As best seen in FIG. 4, sealing assembly is incorporated into each door 18 and 19 and the ends 16 and 17 of the housing 3 to prevent water from entering the housing 3. More specifically, left and right door receiving frames 101 and 102 extend around an inner surface of the storage box housing 3 adjacent the left and right ends 16 and 17 thereof and define the left and right housing openings 14 and 15. The frames 101 and 102 are formed from strips of angle iron 105 welded to the inner surface of the housing 3 so as to extend along the front panel 6, cover 8, rear panel 7 and across the open bottom 9. A vertical leg 106 of each angle iron 105 extends inward from the housing 3 towards the interior and a horizontal leg 107 extends perpendicular to the vertical leg 106 and outward relative to the associated opening 14 or 15. The vertical leg is spaced inward from the associated end 16 or 17 of the housing 3 so that the outer end of the horizontal leg 107 does not extend beyond the end 16 or 17 of the housing 3. A channel is thereby formed between the angle iron 105 and the housing 3 around the periphery of the associated openings 14 and 15.

Each door 18 and 19 is formed from a sheet of metal shaped in a geometry corresponding to but slightly smaller than the ends 16 and 17 of the housing 3 to fit in the ends 16 and 17 and completely cover the openings 14 and 15 defined by the door receiving frames 101 and 102. An inwardly turned lip 111 is formed around the periphery of each door 18 and 19. A hinge pin 115 is welded to each door 18 and 19 along a rear edge 117 thereof so that stub ends 118 (only the upper one of which is seen) of the hinge pin 115 extend above and below the top and bottom edges of the doors 18 and 19 respectively.

Hinge pin receivers or pivot bearings 121 (only the upper one of which is shown) are welded or bolted to the housing 3 proximate the top, rear corner and the bottom, rear corner respectively. The stub ends 118 of each pivot pin 115 are received in holes in the pivot bearings 121 to form a pivotal or hinged connection between the doors 18 and 19 and the housing 3. Although the doors 18 and 19 are shown connected by hinges to the rear panel 7 of the housing 3, it is foreseen that the doors 18 and 19 could be pivotally connected relative to any of the housing panels, including the front panel 6, cover panel 8 or across the open bottom 9.

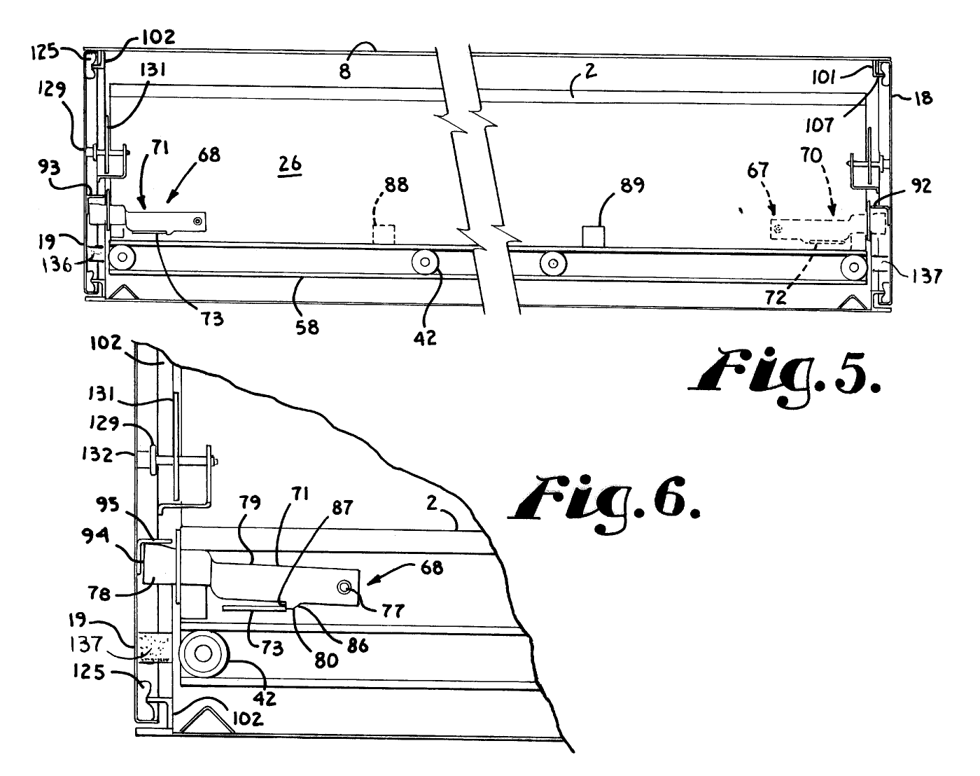

A foam sealing strip 125, shown in FIG. 4, is adhered to an inner surface of each door 18 and 19 around the periphery thereof and just inside the peripheral lip 111. As best seen in FIGS. 5 and 6, when the doors 18 and 19 are pivoted to a closed position, the sealing strip 125 is preferably positioned to be compressed against the horizontal leg 107 of the door receiving frames 101 and 102 respectively. The outer surface of each door 18 and 19 also preferably extends either flush with the housing ends 16 or 17 or slightly recessed relative thereto. The engagement of the sealing strip 125 against the door receiving frames 101 and 102 functions to prevent any water that infiltrates between the housing 3 and the edge of the doors 18 and 19 from entering the interior of the housing 3. Instead the water should flow in the channel formed by the frames 101 and 102 and the cover 3 and out the gap between the bottom of the doors 18 and 19 and the open bottom 9 of the housing 3. Water is thereby prevented from entering the housing 3 and collecting in the bottom of the tray 2 or the bottom of the housing 3.

A quarter turn latch 129 is mounted to each door 18 and 19 and includes a pivotal latch member 131 which extends inward of the respective door receiving frame 101 and 102 when the doors 18 and 19 are closed. The latch members 131 may be rotated behind the associated frames 101 and 102 to hold the doors 18 and 19 in the closed position. Each latch 129 includes a lock 132, such as a keyed lock, for locking the doors 18 and 19 shut.

Cushions 136 and 137 are preferably mounted on inner surfaces of doors 18 and 19 respectively to engage the end walls of the tray 2 when the doors are shut to help hold the tray 2 in place and reduce any rattling noises and the like which might result from un-dampened movement of the tray 2 as the truck 4 moves. More specifically, even though the latch members 70 and 71 generally engage the latch keepers 72 and 73 to hold the tray 2 in the retracted position, the distance between the outer edges of the latch keeper teeth when the latch members 70 and 71 are in the lowered position, will be slightly greater than the distance between the inner edges of the latch keepers 72 and 73 to allow the latch members 70 and 71 to pivot into and out of engagement with the latch keepers 72 and 73. Therefore, unless the tray 2 is further restrained, it will be allowed to move back and forth slightly which may result in a rattle under certain driving conditions. The cushions 136 and 137 may be formed from closed cell foam that is adhered to the inner surface of the doors 18 and 19. The cushions 136 and 137 are formed of a length that is long enough and are positioned to engage the tray end walls 27 and 28 respectively when the doors 18 and 19 are closed with some compression of the cushions 136 and 137. The cushions 136 and 137 thereby biasingly hold the tray 2 in a retracted position to minimize any rattling or other noise created by movement of the tray 2.

It is foreseen that the cushions, dampeners or restraining members 136 and 137 could be of a wide variety of forms designed to hold the tray 2 in place. For example, the cushions could be spring loaded or cam actuated or formed from material other than closed cell foam and including spring steel. It is also foreseen that the restraining members 136 and 137 could be mounted on the end walls 27 and 28 of the tray 2 to engage the respective doors 18 and 19 when closed. The restraining members may also be connected to the doors 18 and 19 or tray 2 by means other than adhesive, including by bolting or wielding structure thereto. It is also foreseen that the restraining members 136 and 137 could be used to hold the tray 2 in the retracted position when the doors 18 and 19 are closed, without use of separate latch members, such as latch members 70 and 71.

To install the storage box 1, the roller support beams 46 and 47 with the rollers 42 bolted thereto are bolted to the front and rear panels 6 and 7 of the housing 3. Only one of the latch keepers 72 or 73 is bolted in place to the associated roller support beam 46 or 47. For example, the right or second latch keeper 73 may be bolted to the rear roller support beam 47 so that the latch keeper 73 is positioned proximate the right opening 15 of the housing 3. The tray 2 may then be inserted into the housing 3 through the left opening 14. The tray 2 is slid into the housing 3 until the outer edge 87 of the latch finger 80 on the latch member 71 connected to the rear sidewall 26 of the tray 2 abuts against the latch keeper 73 on the rear roller support beam 47. The first or left latch keeper 72 may then be bolted in place to the front roller support beam 46 so that the latch keeper 72 extends in front of the latch finger 80 on the first latch member 70.

The housing 3 is then bolted to the surface of the secondary structure to which it is to be attached, such as a flat bed, by driving screws through the mounting flanges 52 on the roller support beams 46 and 47 which are connected to and may be considered part of the housing 3. Access to the mounting flanges 52 is gained by sliding the tray 2 out the opposite end of the housing from the end to be bolted down. If the tray 2 needs to be completely removed from the housing 3, one of the latch keepers 72 or 73 can be unbolted and removed to allow the tray 2 to be slid out the associated end of the housing 3.

The storage box 1 may be used in applications other than mounting on the bed of a flat bed truck. The storage box 1 may be adapted for mounting across the sidewalls of a standard pick-up truck, across the frame of a trailer or across the frame of a truck-type tractor. It is foreseen that in these applications, the housing 3 would likely include a bottom panel instead of an open bottom as with the embodiment disclosed above. It is also foreseen that a storage box 1 of the type disclosed, could be mounted beneath the bed of a flat-bed trailer generally running lengthwise relative to the trailer. In such an application, the top of the housing would likely be formed as an open top and a housing panel would be formed across the bottom thereof and below the storage tray 2. The bottom housing panel may still be referred to as a cover or cover panel.

Referring to FIG. 7, there is shown an alternative embodiment, wherein the storage box 141, similar in construction to storage box 1, is built into the base 143 of a headache rack 144 of a flat bed truck 145. In the embodiment as shown in FIG. 1, the storage box 1 is positioned adjacent the frame members forming the headache rack, but it is not integrated into the base thereof.

It is to be understood that while certain forms of the present invention have been illustrated and described herein, it is not to be limited to the specific forms, process steps or arrangement of parts described and shown and that the invention should be limited only by the claims. For example, it is foreseen that the moveable latch member could slide vertically instead of pivoting. It is also foreseen that the latch keepers could be mounted on the tray sidewalls and the latches mounted on the roller support beams 46 and 47 or the housing sidewalls 6 and 7.

It is also foreseen that the geometry of the housing 3 and the tray could be varied 2. For example, the housing could have a rectangular cross-section with a flat top cover and the sidewalls of the associated tray could be of the same height to present a rectangular cross-section as well. Storage boxes having a rectangular cross-section would be more conducive to allowing one storage box to be stacked on top of another to provide multiple trays for storing more tools and equipment.

It is also foreseen that the latch engagement members could be of different configurations while still engaging the moveable latch member to hold it from coming unlatched when the associate door is closed. For example each latch engagement members could be formed as a bail projecting inward from an inner surface of the associated door 18 or 19. The engagement member could extend into a slot, recess or other receiver formed in the grip end 78 of the latch member.

What is claimed is:

1. A storage box for mounting to a secondary structure comprising:
a housing including first and second spaced apart sidewalls and first and second open ends;
a tray slidably mounted within the housing and to the sidewalls, wherein said tray is slidable out either open end; and
first and second doors connected to the housing across said first and second open ends respectively and selectively advanceable into and out of closed relationship therewith.

2. The storage box as in claim 1 wherein said first and second doors are hingedly connected to said housing proximate said first and second open ends respectively and include a seal mounted on an inside surface thereof, each of said seals engaging a door frame assembly formed in each open end of said housing to form a seal between each of said doors and an interior of said housing when said doors are advanced into closed relationship with said housing.

3. The storage box as in claim 1 wherein a bottom of said housing is open and mounting flanges are formed along lower edges of said first and second sidewalls; said mounting flanges having fastener receivers formed therein for receiving a fastener for connecting said storage box to a secondary structure.

4. The storage box as in claim 1 wherein said tray is slidably mounted on a plurality of roller bearings projecting inward from said sidewalls of said housing.

5. The storage box as in claim 1 wherein first and second stop members are mounted on first and second sides of said tray respectively; said first and second stops selectively engaging first and second stop engaging members connected to said first and second sidewalls of said housing respectively to limit the length of said tray that may be advanced out of said first and second open ends respectively.

6. A storage box comprising:
a housing including first and second open ends;
a tray slidably mounted within the housing and slidable out either said first or second open end;
a first latch assembly having a first movable latch member and a first latch keeper; said first movable latch member engaging said first latch keeper when said tray is advanced to a retracted position within said housing to prevent said tray from advancing out of said first open end of said housing; said first movable latch member selectively movable out of engagement with said first latch keeper to allow said tray to be advanced out of said first open end of said housing;
a second latch assembly having a second movable latch member and a second latch keeper; said second movable latch member engaging said second latch keeper when said tray is advanced to a retracted position within said housing to prevent said tray from advancing out of said second open end of said housing; said second movable latch member selectively movable out of engagement with said second latch keeper to allow said tray to be advanced out of said second open end of said housing;
a first door mounted relative to said first open end of said housing and selectively advanceable into and out of covering relationship with said first open end; said first door having a first latch engagement member mounted thereon and engaging said first latch member when said first door is advanced into covering relationship with said first open end to prevent disengagement of said first latch member from said first latch keeper;
a second door moveably mounted relative to said second open end of said housing and selectively advanceable into and out of covering relationship with said second open end; said second door having a second latch engagement member mounted thereon and engaging said second latch member when said second door is advanced into covering relationship with said second open end to prevent disengagement of said second latch member from said second latch keeper.

7. The storage box as in claim 6 wherein said first and second doors are hingedly connected to said housing proximate said first and second open ends respectively and include a seal mounted on an inside surface thereof, each of said seals engaging a door frame assembly formed in each open end of said housing to form a seal between each of said doors and an interior of said housing when said doors are advanced into closed relationship with said housing.

8. The storage box as in claim 6 wherein a bottom of said housing is open and mounting flanges are formed along lower edges of said first and second sidewalls; said mounting flanges having fastener receivers formed therein for receiving a fastener for connecting said storage box to a secondary structure.

9. The storage box as in claim 6 wherein said tray is slidably mounted on a plurality of roller bearings projecting inward from said sidewalls of said housing.

10. A storage box comprising:
a housing including front and rear panels, a cover panel and first and second open ends;
a tray slidably mounted within the housing and slidable out either open end; said tray having a floor, front and rear sidewalls, first and second end walls and an open top;
a first latch and stop assembly having a first latch member moveably mounted on said front sidewall of said tray proximate said first end wall; a first latch keeper connected to said front panel proximate said first open end and a first stop mounted on said front sidewall of said tray in spaced relation from said first latch member and toward said second end wall; said first latch member engaging said first latch keeper when said tray is in a closed alignment relative to said housing to prevent said tray from sliding out said first open end; said first latch member manually movable out of engagement with said first latch keeper to permit said tray to slide out said first open end; and said first stop positioned to engage said first latch keeper when said tray is slid out of said first open end to prevent said tray from sliding out said first open end beyond a selected distance;
a second latch and stop assembly having a second latch member moveably mounted on said rear sidewall of said tray proximate said second end wall; a second latch keeper connected to said rear panel proximate said second open end and a second stop mounted on said rear sidewall of said tray in spaced relation from said second latch member and toward said first end wall; said second latch member engaging said second latch keeper when said tray is in a closed alignment relative to said housing to prevent said tray from sliding out said second open end; said second latch member manually movable out of engagement with said second latch keeper to permit said tray to slide out said second open end; and said second stop positioned to engage said second latch keeper when said tray is slid out of said second open end to prevent said tray from sliding out said second open end beyond a selected distance;
a first door hingedly connected to said housing adjacent said first open end;
a second door hingedly connected to said housing adjacent said second open end;
a first latch engaging member connected to said first door and advaceable into engagement with said first latch member when said first door is advanced into covering relationship with said first open end to prevent said first latch member from disengaging said first latch keeper; and
a second latch engaging member connected to said second door and advaceable into engagement with said second latch member when said second door is advanced into covering relationship with said second open end to prevent said second latch member from disengaging said second latch keeper.

11. The storage box as in claim 10 wherein said first and second doors are hingedly connected to said housing proximate said first and second open ends respectively and include a seal mounted on an inside surface thereof, each of said seals engaging a door frame assembly formed in each open end of said housing to form a seal between each of said doors and an interior of said housing when said doors are advanced into closed relationship with said housing.

12. The storage box as in claim 10 wherein a bottom of said housing is open and mounting flanges are formed along lower edges of said first and second sidewalls; said mounting flanges having fastener receivers formed therein for receiving a fastener for connecting said storage box to a secondary structure.

13. The storage box as in claim 10 wherein said tray is slidably mounted on a plurality of roller bearings projecting inward from said sidewalls of said housing.

14. A storage box comprising:
a housing including an open end;
a tray slidably mounted within the housing and slidable out said open end;
a latch assembly having a movable latch member and a latch keeper; said movable latch member engaging said latch keeper when said tray is advanced to a retracted position within said housing to prevent said tray from advancing out of said open end of said housing; said movable latch member selectively movable out of engagement with said latch keeper to allow said tray to be advanced out of said open end of said housing;
a door mounted relative to said open end of said housing and selectively advanceable into and out of covering relationship with said open end; said door having a latch engagement member mounted thereon and engaging said latch member when said door is advanced into covering relationship with said open end to prevent disengagement of said latch member from said latch keeper.

15. The storage box as in claim 14 wherein said door is hingedly connected to said housing proximate said open end and includes a seal mounted on an inside surface thereof; said seal engaging a door frame assembly formed in said open end of said housing to form a seal between said door and an interior of said housing when said door is advanced into closed relationship with said housing.

16. The storage box as in claim 14 wherein said moveable latch member includes a grip end extending past a distal end of said tray toward said open end of said housing when said tray is in said retracted position; said latch engagement member having a horizontal leg extending in closely spaced, overlapping relationship above said grip end of said moveable latch member when said door is in said closed relationship relative to said housing to prevent said latch member from moving out of engagement with said latch keeper and said horizontal leg advanceable out of overlapping relationship with said grip end of said moveable latch member when said door is advanced to an open relationship relative to said housing.

17. The storage box as in claim 14 further comprising a restraining member mounted on one of said door or said tray and engaging the other of said door or said tray when said door is closed to resist movement of said tray within said housing.

18. A storage box comprising:
a housing including first and second open ends;
a tray slidably mounted within said housing and selectively slidable out either said first or second open end from a retracted position;
a first door mounted relative to said first open end of said housing and selectively advanceable into and out of covering relationship with said first open end and a first door latch on said first door selectively latching said first door in a closed position when said first door is advanced into covering relationship with said first open end;
a second door moveably mounted relative to said second open end of said housing and selectively advanceable into and out of covering relationship with said second open end and a second door latch on said second door selectively latching said second door in a closed position when said second door is advanced into covering relationship with said second open end;
a first restraining member mounted on said first door or a first end of said tray and a second restraining member mounted on said second door or a second end of said tray; said first restraining member extending between and in contact with said first door and said first end of said tray when said first door is latched in the closed position and said second restraining member extending between and in contact with said second door and said second end of said tray when said second door is latched in the closed position to resist movement of said tray out of said retratcted position when both said first and second doors are in the closed position.

19. The storage box as in claim 18 wherein said first restraining member comprises a first resilient member mounted on an inner surface of said first door and said second restraining member comprises a second resilient member mounted on an inner surface of said second door.
